(19) United States
(12) Patent Application Publication
(10) Pub. No.: US 2006/0072066 A1
(43) Pub. Date: Apr. 6, 2006

(54) Eyewear with movable protective lens and method of operation

(76) Inventor: Miko Mihelic, Dobrova (SI)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/956,710

(22) Filed: Oct. 1, 2004

(51) Int. Cl. G02C 5/00

(52) U.S. Cl. 351/41

(57) ABSTRACT

Goggles having handless pivotable lenses are provided. The goggles include at least one pair of lenses and a frame. The frame has a chin strap attached thereto. The chin strap enables a wearer to rotate the lenses such that the wearer may maintain the goggles placed on his or her head while not looking through the lenses. The chin strap is positioned underneath the wearer's chin. When the wearer does not wish to use at least one pair of lenses, the wearer opens his or her mouth to rotate the lenses. A linkage assembly operably coupled to the lenses and chin strap operate to rotate the lenses when the wearer opens his or her mouth. When the wearer closes his or her mouth, a spring provided in the linkage assembly facilitates rotation of the lenses back to an original position. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to eyewear having lenses that can be moved into and out of operating position using an actuator assembly.

### BACKGROUND OF THE INVENTION

Protective goggles or glasses are known for use to protect a wearer's eyes from dangerous light and/or debris. For example sunglasses or light protecting lenses or coverings are known to shield eyes from sunlight or industrial light, such as sparks and welding processes. One disadvantage of such dark lenses is that they may be appropriate for use when exposed to high brightness light, but impair vision when used in ambient lighting.

Welder eyewear, including goggles and masks, is an example of protective eyewear. Such welder eyewear typically has a dark lens or shield that is manually flipped into position covering the user's field of view as needed. For example, when welding, a welder will need to protect eyes from high brightness light and flying debris, such as sparks or particles. The dark lens or shield can be uncomfortably dark for use in ambient light, so in use the welder frequently will manually flip up the lens or shield so as to have a clearer field of vision—when not actively welding. In operation, the flipping up and down of the lens or shield may need to be performed repeatedly in order to view workpieces, position them, or otherwise handle equipment without obstructed view, and then as needed perform welding operations with eyes protected by the lens or shield.

A disadvantage of this known eyewear solution is that welders often need to use their hands to perform the welding process, both prior to welding and during the welding operation. Using a hand for flipping a lens or shield up or down means that it needs to be made free for doing so, leading to inefficiency, frustration and inaccuracy. For example a hand typically is needed to hold the welding pistol and a hand is needed to hold or position pieces being welded or other tools and equipment. When it is necessary to flip the lens, the welder needs to make a hand free, such as by putting down the welding equipment or a workpiece. This results in moving either the welding equipment or workpiece from the operating position in which the welder previously had positioned them, so as to enable the manual lens motion.

Other types of protective eyewear with movable lenses also is known. One type is pivotable sunglasses, in which sunglass lenses are rotatably mounted on clear frames or corrective eyeglasses. Such pivotable sunglasses suffer the disadvantage that the lenses need to be rotated manually.

Other types of protective eyewear are also used, in which a pivotable lens is not provided. Those types of eyewear suffer a disadvantage in that they are not flexible in operation, providing only a single lens system, and switching lenses requires removing the eyewear, thereby losing the protective function. One example of such eyewear is ski goggles, either with clear or tinted lenses. Another example is hazardous environment goggles or glasses, such as worn in environments prone to wind blown sand or dust. A further example is riding goggles, such as motorcycle goggles. A further example is standard sunglasses.

Therefore, there exists a need for eyewear having protective lenses that can be applied or removed without manual operation.

### SUMMARY OF THE INVENTION

The present invention alleviates to a great extent the disadvantages of known eyewear, some of which are discussed above, by providing eyewear having one or more lenses that can be applied to a field of view, or removed, without manual operation. More particularly, eyewear is provided having an assembly for moving one or more lenses into and out of a field of view. In the illustrated embodiment, a lens assembly is pivotally mounted on a frame whereby it can be pivoted into and out of a field of view using a pivoting assembly not requiring operation by hand. Although an embodiment in which the lens assembly is pivotally mounted is illustrated, it should be understood that the present invention relates to any mechanism where the lens assembly can be moved into and out of a field of view without manual operation. For example, it can be slidably or otherwise dispaceably mounted.

In one embodiment of the invention, goggles such as welder's goggles are provided having a pivotally mounted lens assembly operable via a linkage assembly. Other examples of such goggles are motorcycle goggles, hazardous weather goggles and ski goggles, having movable lens assemblies thereon. Likewise, a welder's protective mask can be provided in which the protective lens is movable via the linkage assembly. In an operating position, the pivotable lenses are positioned in front of a wearer's eyes. In a retracted position, the lenses are moved out of the field of view, such as in the illustrated embodiment by pivoting them about a pivot axis such that the lenses are no longer are fully in front of the wearer's eyes. This enables the wearer to have a line of sight that is substantially not viewed through the lenses.

The pivotable lenses optionally can be clear, lightly tinted or highly tinted depending on the use. It should be noted that the goggles of the illustrated embodiment optionally are fitted clear, or less tinted lenses, in addition to the pivotally mounted lenses. In this way, eye protection is provided whether or not the pivotally mounted lens assembly positions the pivotable lenses in the field of view. Alternatively, no other lenses are provided other than the tinted lenses.

The pivotable lenses are mounted to a frame about a pivot axis. In the illustrated embodiment, the pivot axis is located substantially parallel to and at a point above the first set of lenses, although the pivot axis can be at any location as well, such as on a side or bottom of the frame. A linkage assembly is provided that is operated to pivot the lenses into and out of the field of view as desired. It is preferred that hands-free operation be enabled by the linkage assembly, although it should be understood that a manually operated linkage assembly can be provided as well such that the pivotally mounted lenses can be pivoted as desired.

The linkage assembly as illustrated includes an actuator that can be grappled by the user to move the lenses as desired. In the illustrated embodiment, a chin actuator is provided, although foot operated or hand operated or third party operated actuators may be may provided as well, or alternatively. According to one embodiment of the present invention, the chin actuator is a strap positionable under the user's chin that optionally is adjustable to different lengths to accommodate wearers with different sized heads. The chin strap may be adjustable using, for example, hook-and-loop fasteners, belt-type notches, elastic material or any other known adjustment mechanism. In operation of the chin actuator, the user can move his or her mouth so as to actuate the linkage assembly. In the illustrated embodiment, the mouth is opened, although the mouth optionally can be moved side to side or in other motions sufficient to operate the linkage assembly. When the wearer desires to rotate the pivotable lenses, the wearer optionally opens his or her mouth. The chin strap causes a hinge member connected to the pivotable lenses through a hinge to rotate about a pivot axis. This in turn also causes the pivotable lenses to rotate about the pivot axis and be in a rotated position. The pivotable lenses are then substantially removed from the wearer's line of sight. The pivotable lenses remain substantially in the rotated position for as long as the wearer maintains his or her mouth open, or optionally the linkage assembly can lock in the desired position, allowing freer mouth motion. After the wearer closes his or her mouth, the pivotable lenses return to the normal position.

In an alternate embodiment of the present invention, the linkage assembly is actuated by foot or hand actuation. For example, when the wearer steps on a foot pedal or the foot is otherwise moved, the lenses are caused to move about the pivot axis as described above.

In another embodiment of the present invention, the linkage assembly is actuated by a button or other mechanism that, when depressed, causes the linkage assembly to rotate the pivotable lenses about the pivot axis. The button may be mounted, for example, on a hip, arm, leg or other body part of a wearer that enables the wearer to depress the button. In an alternative embodiment, the linkage assembly is actuated by a manually or foot operated strap that when pulled causes the linkage assembly to rotate the lenses, and when released allows the lenses to return to resting position in the field of view.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a front perspective view of an embodiment of eyewear in accordance with the present invention;

FIG. 2 is a side view of the eyewear embodiment illustrated in FIG. 1 mounted on a head of a wearer in accordance with the present invention;

FIG. 3 is a front perspective view of an embodiment of eyewear in accordance with the present invention with pivotable lenses positioned outside of a field of view;

FIG. 4 is a front perspective view of an embodiment of eyewear in accordance with the present invention mounted on a head of a wearer;

FIG. 5 is a side view of an embodiment of eyewear mounted on a head of a wearer in accordance with the present invention; and

FIG. 6 is a side view of an embodiment of eyewear mounted on a head of a wearer in accordance with the present invention.

It will be recognized that some or all of the Figures are for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

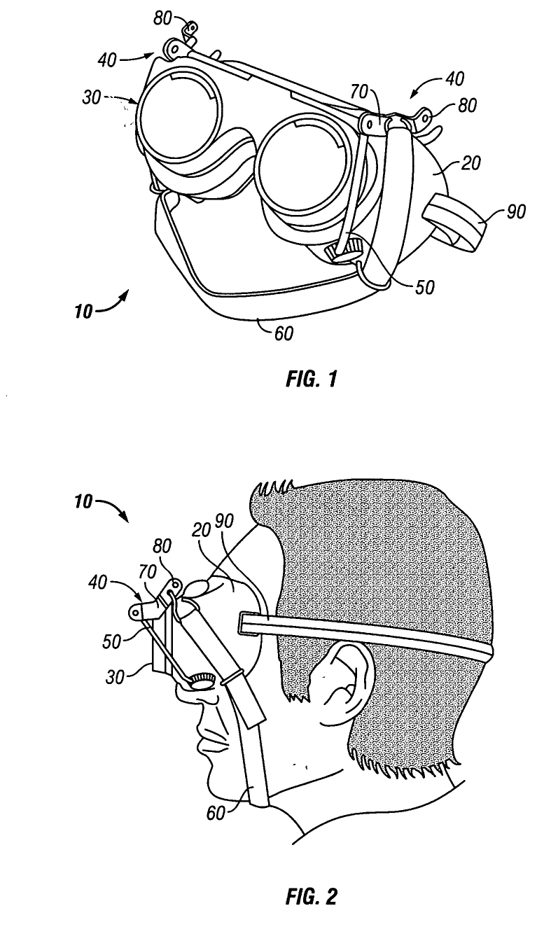

Referring to FIGS. 1 through 4, one embodiment of eyewear 10 of the present invention is illustrated. It should be noted that although the illustrated embodiment depicts eyewear 10 that are goggles, any type of eyewear having the movable lenses of the present invention may be practiced. Examples include glasses, sunglasses, welder's masks, welder's goggles, ski goggles, riding goggles such as motorcycle goggles, hazardous weather goggles etc. The illustrated embodiment includes an optional mounting frame 20, pivotable lens assembly 30 (also referred to as pivotable lenses), linkage assembly 40, biasing assembly 50 and actuator 60. The pivotable lenses 30 are pivotally mounted to the frame 20 via the linkage assembly 40. It should be understood that although a particular linkage assembly is illustrated (such as including member 70, biasing assembly 50 etc.) any form of linkage assembly that can receive force input such as via operation of actuator 60 and translate that input into motion of the lenses 30 can be selected. The linkage assembly 40 operates such that the lenses 30 are positioned in front of a wearer's eyes in a normal position and substantially out of the line of sight of the wearer when in a rotated position.

In an embodiment, the lenses 30 are biased in one direction, such as in position, i.e. in the user's line of sight, or alternatively out of position out of the user's line of sight. A biasing assembly 50 may be provided to bias the lenses 30 in the desired direction. The biasing assembly 50 may be, for example, an elastic band such as a rubber band, linear or leaf spring or any other biasing mechanism that operates sufficiently to bias the lenses 30 in the desired direction. Preferably, the lenses 30 are biased in the direction of being lowered into the line of sight of the wearer.

The actuator 60 is operated in order to move the lenses 30 away from the normal position (i.e. the biased position). Alternatively, it may be operated to achieve other movement of the lenses 30. In the illustrated embodiment, the actuator 60 is in operative contact with the linkage assembly 40 whereby operation of the actuator transmits motion to the lenses 30 via the linkage assembly. However, it should be understood that the actuator 60 may operate upon other elements of the eyewear 10, such as on the lens assembly 30. Any connection may be selected that transmits force to the lens assembly 30 in order to move the lenses. In an alternative embodiment, the actuator may transmit an electrical or wireless signal to a translation mechanism that moves the lenses 30.

In the illustrated embodiment, the actuator 60 is displaced transmitting motive force to member 80 of the linkage assembly 40. Member 80 is pivotally mounted on the frame 20 whereby motion transmitted via operation of actuator 60 is transmitted to the lens assembly 30 in opposite rotational direction. So, if the actuator pulls down on member 80, the member rotates such that the lens assembly 30 connected to it (directly or indirectly) pivots upwards, i.e. either completely or partially out of the user's line of sight (also referred to as field of view).

According to one embodiment of the presenting invention, the actuator 60 comprises a chin strap or jaw strap (the actuator 60 also is referred to herein as a chin actuator). The chin strap is attached to the linkage assembly 40 such as at members 80 on opposite sides of frame 20. When the eyewear 10 is worn by a user, the chin strap is positioned underneath the user's chin. When the user displaces his or her jaw, the actuator 60 is displaced, and the motive force of the actuator 60 displacement is transmitted to the lens assembly 30 via the member 80. This motion can be imparted by any desired motion of the jaw providing sufficient motion of the actuator 60, such as opening the user's mouth or moving the jaw side to side. This partially or completely can remove the pivotable lenses 30 from the wearer's line of sight. In order to return the lenses 30 to the normal position, the actuator 60 is moved again, allowing lenses to move. In the preferred embodiment, the biasing assembly 50 operates to return the lenses to the desired position. In an alternative embodiment, the lenses 30 are biased by biasing assembly 50 out of the line of sight (for example rotated up or otherwise away from the user's field of view) and operation of actuator 60 causes the lenses 30 to move into position via transmitting force via the linkage assembly 40.

In operation of the illustrated embodiment, a user positions the eyewear 10 on his or her head. The lenses 30 are biased via the biasing assembly 50 into the normal position within the user's line of sight. When the user desires to move the lenses 30, the user operates the actuator 60 by moving his or her jaw, such as opening his or her mouth, with sufficient force to overcome the biasing force imparted by the biasing assembly 50 whereby the lenses 30 are pivoted upwards.

An optional head strap 90 is provided to assist in securely mounting the eyewear 10. It should be understood that regular glasses arms also may be used for mounting. The head strap 90 may optionally be adjustable and/or be composed of an elastic material.

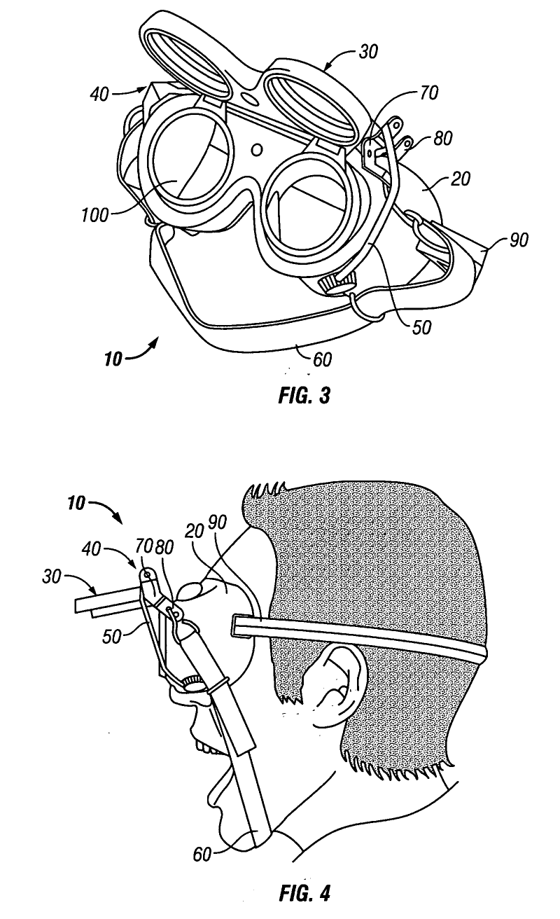

According to one embodiment of the present invention, the goggles 10 are welder's goggles. Therefore, the pivotable lenses 30 include dark lenses to protect the welder's eyes from dangerous light. According to one embodiment of the present invention, the goggles 10 are also provided with substantially clear or lightly tinted lenses 100 as shown in FIG. 3. The lenses 100 may be used to provide the wearer with additional protection when the pivotable lenses 30 are in the rotated position out of the user's line of sight. This would provide the wearer with protection from debris while the pivotable lenses 30 are in the rotated position.

Alternatively, the goggles 10 may be provided only with the pivotable lenses 30. Therefore, when the pivotable lenses 30 are rotated, the wearer has a line of sight that substantially does not include eye protection. This may be desirable for ski goggles or other eyewear in which fogging or other lens obstruction can be a concern.

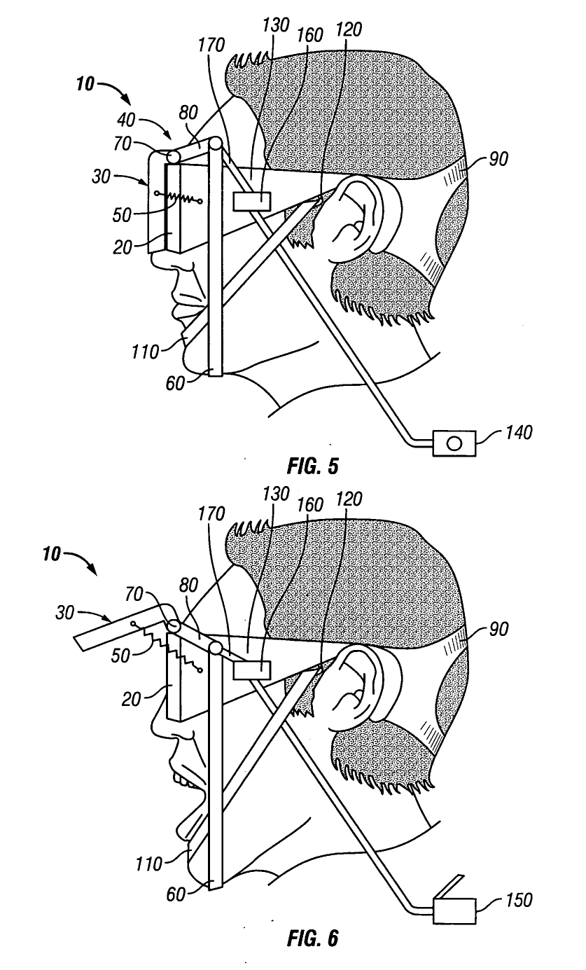

An alternative embodiment of the presenting invention is illustrated in FIGS. 5 and 6. In this embodiment, a support strap 110, eyelets 120, and earpieces 130 are provided. The eyewear may include a conventional spectacles having pivotable lenses 30 mounted thereon. The head strap 90, however, may be attached to the earpieces 130. A support strap 110 may also be included to provide additional support to the glasses 10 on the wearer's head. The support strap 110 may include an adjustment mechanism as described above or be composed of an elastic material. The support strap 110 may be attached to the glasses 10 by eyelets 120 connected to the earpieces 130. The support strap 110 may extend from one eyelet 120, diagonally along a wearer's cheek, in front of the wearer's chin to the other eyelet 120 in the same manner.

As discussed above, the pivotable lenses 30 may include dark lenses to protect a wearer from dangerous light and/or debris. According to one embodiment of the present invention, the glasses 10 also include standard lenses as described above. The standard lenses may be used to protect the wearer's eyes when the pivotable lenses 30 are in the rotated position. The standard lenses may be, for example, clear lenses that are used to prevent debris from entering the wearer's eyes.

In an alternative embodiment, the lens assembly 30 includes as already discussed one or more lenses, which optionally are tinted, and also includes a mask member that mounts the one or more lenses. The mask member preferably is elongated such that the lens(es) only cover a portion of the mask surface. The mask optionally is sized to be long enough to cover the full length of a typical user's face. Examples of lengths are 6 inches, 1 foot, 1.5 feet, 2 feet etc. to any desired length.

FIGS. 5 and 6 also illustrate that the actuator 60 may include switch 140, which may be a button or foot pedal 150. The wearer may operate the switch to rotate the pivotable lenses 30. In a mechanical example, the switch is operated to transmit mechanical force to the linkage assembly at member 80. The switch 140 (or foot pedal 150) may be used in conjunction with a pneumatic or other type device 160 that causes the hinge member 80 to rotate about the pivot 70 and cause the pivotable lenses 30 to rotate.

The device 160 includes a connecting member 170 that connects the device 160 to the hinge member 80. When the switch 140 or foot pedal 150 is depressed, this causes device 160 to move hinge member 80 such that pivotable lenses 30 are rotated about pivot 70. This may be performed to place the pivotable lenses 30 in the rotated position or normal position. It is to be understood that the device 160 may be located in any suitable position. For example, the device 160 need not be located on the earpiece 130, but may include a connecting member 170 of sufficient length such that the device 160 may be placed on a table, the floor or other location. It should also be understood that the device 160 may be used either alone, in conjunction with the actuator 60 or not at all.

The switch 140 may be placed, for example, on a wearer's hip, arm, leg or other body part that enables the wearer to push the switch 140 against a surface, for example, a table leg or wall, that is sufficiently rigid to cause the button 140 to be depressed.

The switch 140 may operate in a toggle manner. Therefore, the button 140 or foot pedal 150 is depressed each time the wearer desires to rotate the pivotable lenses 30 from one position to another. Alternatively, the switch 140 and foot pedal 150 may operate in a continuous manner such that as long as the switch 140 or foot pedal 150 are depressed, the pivotable lenses 30 remain in the rotated position. Releasing the switch 140 or foot pedal 150 returns the pivotable lenses 30 to the normal position.

Although the invention has been described with reference to welder's goggles and glasses, it should be understood that the invention may be practiced with any type of goggles or glasses. For example, the invention may be practiced with ski goggles, marksman glasses, motocross or racing goggles, and any other type of goggles or glasses.

Thus, it is seen that eyewear that include hands-free pivotable lenses is provided. One skilled in the art will appreciate that the present invention can be practiced by other than the above-described embodiments, which are presented for purposes of illustration and not of limitation. The description and examples set forth in this specification and associated drawings only set forth embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. Eyewear including a mounting frame comprising:
at least one lens;
a linkage assembly movably connecting the lens to the mounting frame; and
an actuator operably connected to the lens.

2. The eyewear of claim 1 wherein the actuator is mounted to the linkage assembly.

3. The eyewear of claim 1 wherein the at least one lens is pivotally mounted to the mounting frame via the linkage assembly.

4. The eyewear of claim 3 wherein operation of the actuator actuates the linkage assembly to pivot the at least one pair of lenses about a pivot axis.

5. The eyewear of claim 1, wherein one of the at least one lens comprises at least one tinted lens.

6. The eyewear of claim 1 further comprising a biasing assembly mounted between the mounting frame and the at least one lens wherein the biasing assembly biases the lenses to a first position.

7. The eyewear of claim 6, wherein the biasing assembly includes at least one of a rubber band and a spring member.

8. The eyewear of claim 1 wherein the actuator includes a chin strap.

9. The eyewear of claim 1 wherein the actuator includes a jaw actuated member.

10. The eyewear of claim 1 wherein the actuator includes a switch.

11. The eyewear of claim 1 wherein the actuator includes a foot pedal.

12. The eyewear of claim 1 wherein the at least one lens includes a welder's tinted lens.

13. The eyewear of claim 1 further comprising a lens assembly include the at least one lens.

14. The eyewear of claim 13 further comprising a biasing assembly mounted between the mounting frame and the at least one lens wherein the biasing assembly biases the lenses to a first position.

15. The eyewear of claim 13 wherein the actuator includes a jaw actuated member.

16. Welder's eyewear including a mounting frame comprising:
at least one lens;
a linkage assembly movably connecting the lens to the mounting frame; and
an actuator operably connected to the lens.

17. The welder's eyewear of claim 16 further comprising a lens assembly include the at least one lens.

18. The eyewear of claim 16 further comprising a biasing assembly mounted between the mounting frame and the at least one lens wherein the biasing assembly biases the lenses to a first position.

19. The eyewear of claim 16 wherein the actuator includes a jaw actuated member.

20. The eyewear of claim 17 wherein the lens assembly further includes an elongated mask member on which the at least one lens is mounted.

21. Eyewear including a mounting frame comprising:
means for pivotally mounting at least one lens;
motion actuating means for actuating movement of the at least one lens, including a means for actuation motion via jaw or foot motion; and
a means for operatively linking the at least one lens to the motion actuating means.
